(19) United States
(12) Patent Application Publication
(10) Pub. No.: US 2008/0023532 A1
(43) Pub. Date: Jan. 31, 2008

(54) Three dimensional mailer

(76) Inventor: John Moresi, St. Peters, MO (US)

Correspondence Address: Paul M. Denk;Suite 170, 763 S. New Ballas Rd., St. Louis, MO, 63141, US

(21) Appl. No.: 11/495,943

(22) Filed: Jul. 27, 2006

(51) Int. Cl. B42D 15/00

(52) U.S. Cl. 229/92.8

(57) ABSTRACT

The three dimensional mailer has multiple stacked layers forming a pocket to accept and transport a sample to an intended recipient. The middle layer has the overall dimensions of the mailer in a generally rectangular shape with a rectangular opening die cut to admit a sample. The thickness of the middle layer is determined by the thickness of the sample. The top layer attaches above the middle layer and has a die cut tab for accessing the opening in the middle layer. The bottom layer opposite the top layer provides a backing to the opening. Preferably, the top layer, middle layer, and bottom layer are separate pieces laminated together. Alternatively, the top layer and the bottom layer are contiguous and joined with a spine whereupon the top layer and bottom layer fold upon the spine to contain the middle layer.

### BACKGROUND OF THE INVENTION

This three dimensional mailer relates to sampling devices and more specifically to an improved card for containing a sample. A unique aspect of the present mailer is a pocket accessible through a hinged tab.

Advertisers and companies have sent samples by mail for years. Samples are printed upon the cards as in cosmetic and fragrance samples or attached to the cards as in trinkets and mailable products. Printed and attached samples run the risks inherent in travel through the mails. Printed samples can become damp and lose their effectiveness. Attached samples can fall off a card never to reach the intended recipient. Samples can also be placed within other publication such as magazines, coupon mailers, and the like. Sample inside another publication have protection from the hazards of the mails yet impose the higher cost of a publication upon the intended recipient.

Beyond samplers, the advertising and marketing industries seek an inexpensive mailer that has thickness and carries a sample. As attached samples risk the hazards of the mails, samples within a mailer avoid many of the troubles in mailing. A sample within a mailer is protected on all sides by the body of the mailer. However, the mailer must still meet postal requirements and be cost effective to manufacture and to mail. The thickness of a mailer determines the size of a sample contained therein. Generally a larger sample weighs more. Thus thicker mailers face limits on their height and length like other card mail, and on thickness due to postage costs measured by weight.

The difficulty in providing a three dimensional mailer is shown by the operation of typical mailers. The patent to Jones, U.S. Pat. No. 805,106, shows an advertising and mailing card, which has foldably provided therein a series of linked cards or advertising blanks, which when embedded within the card proper, and its cover closed, provides for storage of the cards therein. The cover, appears to have a window in it, apparently for viewing of the top card within the card proper. This particular prior art, from 1905, at least shows a type of advertising, that stores within a card, and has a cover that overlays the same during closure.

The patent to Unger, U.S. Pat. No. 1,957,374, shows an advertising device which is claimed as a blotter, and has a removable layer through weakened severance lines that can be removed for providing a returned mailing card for the recipient.

The patent to MacHarg, U.S. Pat. No. 2,256,399, shows another mailing card. While portions of the card may be removable apparently to remove the disclosed picture, this device does not appear to be big enough to accommodate any type of novelty item or sample.

The patent to Casanovas, U.S. Pat. No. 2,717,174, shows another postcard or other card with a fragrant pastille. This is just a postcard with a pull tab that allows immediate access to the perfume pastille and provides a mailer for a perfume sample.

The patent to Eisen, U.S. Pat. No. 2,844,901, shows another laminated type of greeting card, identified as a display assembly. It is capable of holding a cut-out portion, which may function as a novelty item. The portion appears to be some type of an intermediate filler part, for the assembly. But, this device is identified as an assembly, for display purposes, and is not necessarily for mailing purposes.

The patent to Takeuchi, U.S. Pat. No. 4,590,111, shows a fragrance releasing sheet article and method of making the same. This is a release sheet, for an article that may be used as a fragrance sampling means, or at least for releasing a fragrance, when it is opened. You can see the structure of the device, it includes its exterior member, having a base plate, a colored pattern on a film, and apparently the fragrance is applied to one of these inner members, such as the releasing member.

The patent to Dojel, U.S. Pat. No. 4,705,301, shows an entrance ticket. This is some type of a flexible rectangular carrier, which can be torn open to reveal the location of a seat.

The patent to Norman, U.S. Pat. No. 4,892,246, shows a postcard with a tear out return postcard. The present invention is not a postcard in the first instance, nor does it have a tear out portion that can be returned. The present invention is not a business form, and this is generally what is defined in the claims of this particular patent.

The patent to Tararuj, U.S. Pat. No. 4,923,063, shows a sample packet for creams and methods of manufacture, not a mailer. It does define the inclusion of a paper sheet within its interior that prevents absorbing any cream, as a sample. The sample packet defines first and second panels, with a line of adhesive applied to one of the panels, that fold over the reservoir of cream, to seal it therein. It also has a frangible opening means, as the pull tab, that can open the sample packet to provide access to the cream.

The patent to Lithwick, U.S. Pat. No. 4,951,404, defines a greeting card or the like. While this card does provide a container, to function as a window, in the center of the card, for holding items, this really is not the structure of the present invention.

The patent to Franklin, U.S. Pat. No. 5,255,456, shows a double layer card unlike the tri-layer, such as the present invention. Furthermore, at its additional area, it is designed for peeling off, during usage.

The patent to Colvin, Jr., et al., U.S. Pat. No. 5,257,823, is upon a personalizable paper product and method. This is just a card where the front has a series of pull open doors and where the back may have notice relating to a party written therein.

The patent to Garrison, et al., U.S. Pat. No. 5,890,743, is a protected card intermediate and method. This is an imprintable card where you can write on it, and it provides a marking, where the upper transparent layer is a film in contact with a release material for apparently providing a form of printing thereon.

The patent to Berman, et al., U.S. Pat. No. 5,953,885, shows another cosmetic sampler and method of making using bulk thin film application techniques. This sampler is not really made out of sheets of thin film, but is laminated together, in the manner of this invention. The present invention incorporates that thicker intermediate layer, and a trinket, promotional item, or sample, can be supplied therein, but it is not made of a series of webs.

The patent to Best, et al., U.S. Pat. No. 6,092,841, does show a promotional one-piece mailer assembly having an integral coupon card. This particular mailer is at least a five-piece item, having perhaps even a seven-piece laminate, for furnishing coupons. While the present invention may be a form of laminate, it IS does not include a plurality of mini-coupons, within a variety of card stock layers that form its structure.

The patent to Berman, et al., U.S. Pat. No. 6,182,420, shows another method of making a cosmetic sampler using bulk thin film application techniques. Once again, the present invention is really not made out thin web materials, for holding cosmetics. This sampler in this patent is not for use for mailer purposes.

The patent to Gu, U.S. Pat. No. 6,282,819, is a design and manufacture of a communicating card. Your mailer does not include any type of electronic module in it that incorporates electronic circuitry, and it just would not be related to the structure and usage of the communicating card as defined and claimed in this particular patent.

The patent to Fuchs, et al., U.S. Pat. No. 6,520,329, is a packaging for planiform objects and products. This particular package is for holding planiform objects, such as pharmaceutical flat bodies, susceptors, cachets, wafers, transdermal therapeutic systems, and drug delivery systems, chewing gum, microchips, and the like. The packaging, as defined in the claims, includes a support card, with cavities therein. Then, a cover film is applied over the cavities, for sealing the objects inside. Then, it includes a flat envelope that surrounds the support card. The present invention is just not fabricated in the exact manner as defined in the claims of this particular patent.

The patent to Berman, et al., U.S. Pat. No. 6,691,872, discloses a method of making a cosmetic sampler using bulk thin film application techniques. This is similar to the previous Berman patents, where they are laminating various sheets of material together, generally of a thin layer of material, and adhering these layers together to hold a cosmetic for sampling purpose therein. This is not a mailer, and it is formed more as a sampler, rather than for holding any promotional type of three dimensional item. The films used in this patented device may be one or two thousandths of an inch.

The patent to Kalvelage, et al., U.S. Pat. No. 6,802,422, discloses a sealed blister assembly which is not the present invention. Then the patent to French, et al., U.S. Pat. No. 6,830,153, is a child-resistant blister pack which is not the form of the present invention. Finally, the design patent to Stamm, Jr., et al., No. D496,268, shows another design for a blister pack which again is not the present invention.

The present art overcomes the limitations of the prior art. That is, in the art of the present invention, a three dimensional mailer, is prepared with a middle layer having an opening bounded by top and bottom layers. The top layer is opened to insert a sample and the bottom layer serves as a back for the opening and contains the sample.

### SUMMARY OF THE INVENTION

The three dimensional mailer has multiple layers stacked upon one another forming a pocket to accept and transport a sample to an intended recipient. The middle layer has the overall dimensions of the mailer in a planar shape, generally rectangular, with a rectangular opening die cut to admit a sample. The thickness of the middle layer is determined by the thickness of the selected sample of product but limited by weight based postage costs. The top layer attaches above the middle layer and has a similar shape as the middle layer but has a die cut tab for accessing the opening in the middle layer. The bottom layer opposite the top layer has a planar shape similar to the middle layer and provides a backing to the opening. In the preferred embodiment, the top layer, middle layer, and bottom layer are separate pieces laminated together. In an alternate embodiment, the top layer has a flap hingedly connected that folds over the present invention. Alternatively, the top layer and the bottom layer are contiguous and joined with a spine whereupon the top layer and bottom layer fold upon the spine to contain the middle layer therebetween.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved three dimensional mailer that has all of the advantages of the prior art mailers and none of the disadvantages.

It is another object of the present invention to provide a three dimensional mailer that may be easily and efficiently manufactured and marketed.

Even still another object of the present invention is to provide a three dimensional mailer that has a middle layer that varies in thickness to accommodate various size samples such as trinkets, candy, tubes of cosmetic, and the like.

Even still another object of the present invention is to provide a three dimensional mailer that has a middle layer with an opening cut therein for a sample, a top layer that provides access to the sample, and a bottom layer that serves as the back of the opening to retain the sample.

Even still another object of the present invention is to provide a three dimensional mailer that can be mailed within regulation sizes at a minimum of weight and hence postage.

Even still another object of the present invention is to provide a three dimensional mailer that has low production cost.

Even still another object of the present invention is to provide a three dimensional mailer made from the fewest layers possible.

Lastly, it is an object of the present invention to provide a three dimensional mailer that fits within existing publications such as magazine and envelope coupon mailers.

These and other objects may become more apparent to those skilled in the art upon review of the invention as described herein, and upon undertaking a study of the description of its preferred embodiment, when viewed in conjunction with the drawings.

### BRIEF DESCRIPTION OF THE DRAWINGS

FIG. 1 shows a top view of the preferred embodiment of the three dimensional mailer constructed in accordance with the principles of the present invention;

FIG. 2 shows a sectional view through the pocket of the preferred embodiment;

FIG. 3 has an exploded view of the preferred embodiment;

FIG. 3A has an exploded view of an alternate embodiment of the top layer;

FIG. 4 describes a top view of an alternate embodiment of the present invention;

FIG. 5 describes a sectional view through the pocket of the alternate embodiment and shows the spine;

FIG. 6 shows a top view of the alternate embodiment unfolded and without the middle layer;

FIG. 7 has an exploded view of the alternate embodiment prior to assembly; and,

FIG. 8 shows the alternate embodiment assembled with the top layer open revealing the pocket.

### DESCRIPTION OF THE PREFERRED EMBODIMENT

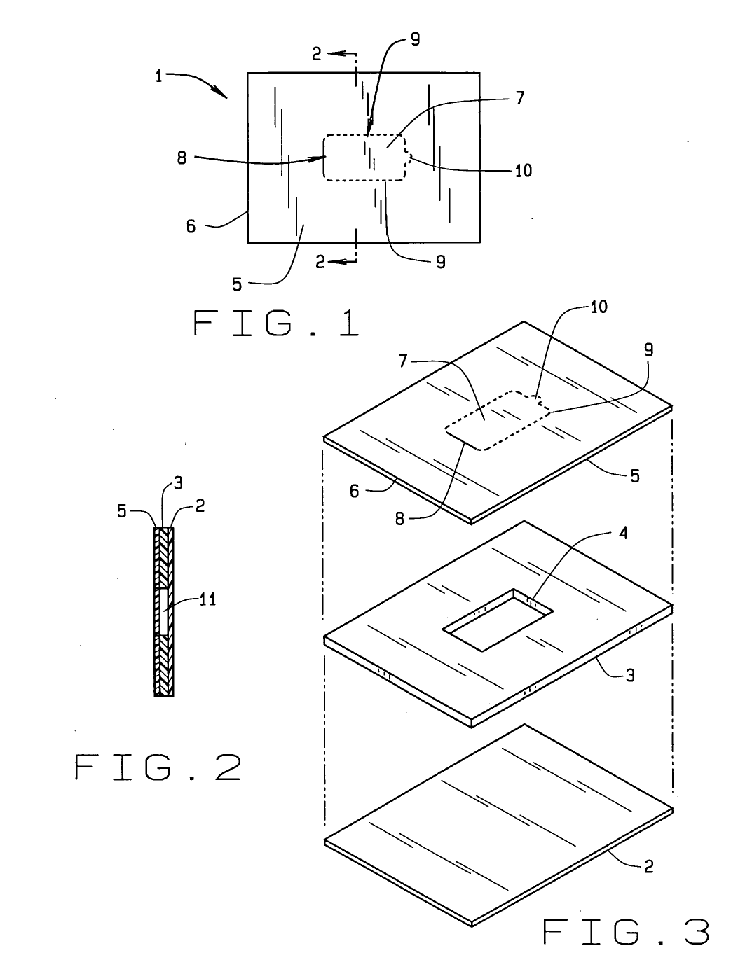

The present art overcomes the prior art by providing a three dimensional mailer, generally rectangular in shape, that contains a sample therein for delivery to and opening by the recipient of the mailer. Turning to FIG. 1, the preferred embodiment of the mailer 1 has a top layer 5 generally rectangular in shape. The top layer has a tab 7 located above the opening 4 in the middle layer 3, here shown as centered though other locations are anticipated. The rectangular tab is formed by a fold line 8 upon one lateral edge 6 and then intermittent linear scoring 9 upon the longitudinal edges and the remaining lateral edge. The remaining lateral edge has a partial knob 10 that extends into the top layer 5 and away from the tab 7. The tab is generally much smaller in dimensions than the mailer. The recipient of the mailer works the knob free from the mailer then pulls the knob towards the fold line thus opening the tab. Behind the tab, the recipient removes the sample contained within the pocket.

The pocket 11 appears in FIG. 2 as a portion of the middle layer 3, one of three layers in the preferred embodiment. The middle layer 3 has a generally rectangular shape to match the top layer 5. The middle layer has a thickness suitable to the sample placed within the mailer. The pocket is formed by removing a rectangular shaped central portion 4 of the middle layer 3. Opposite the top layer, the preferred embodiment has the bottom layer 2. The bottom layer has a rectangular shape also to match the top layer. The bottom layer is continuous and has no scoring or openings there through. The bottom layer serves as the backing to the pocket and assists in retaining a sample in the pocket along with the top layer.

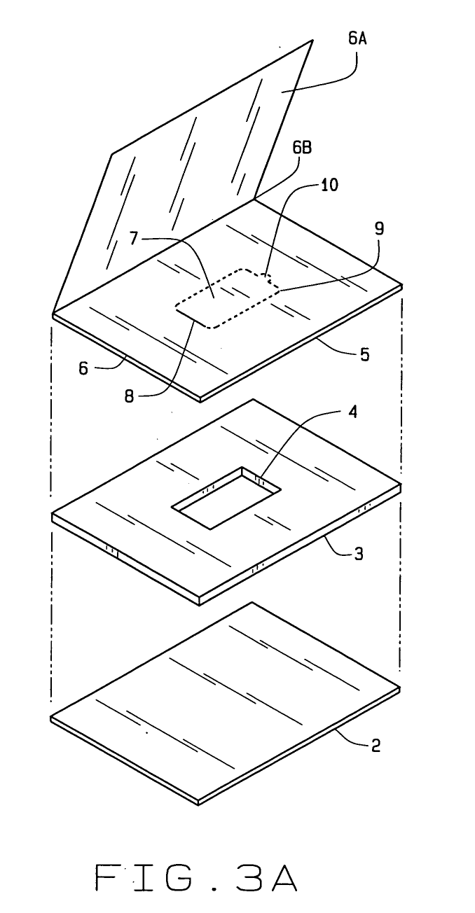

The layers of the preferred embodiment are assembled as shown in FIG. 3. The bottom layer is placed down first then an adhesive is applied to the bottom layer. Then the middle layer is applied to the adhesive surface of the bottom layer. The middle layer is oriented to match the shape of the bottom layer. Then further adhesive is applied to the middle layer opposite the bottom layer. A sample is then placed within the opening of the middle layer. The sample is slightly less in thickness than the middle layer and fits within the dimensions of the opening. Next, the top layer is applied to the middle layer upon the adhesive. The top layer is oriented to also match the shape of the bottom layer and the middle layer. The top layer is then positioned so the tab is centered upon the opening in the middle layer and above the sample. The three layers are then pressed together to firmly bond them and the sample within a pocket formed by the three layers.

In an alternate embodiment shown in FIG. 3A, the top layer 5, has a flap 6a that folds over the top layer 5. The flap 6a joins to the top layer on a fold line 6b or living hinge, generally along a longitudinal edge of the mailer 1 and preferably towards the upper edge of the finished mailer. When folded, the flap has similar dimensions to the top layer. In a still further alternate embodiment, the bottom layer 2 also has a flap of similar construction as the flap for the alternate embodiment of the top layer as described. In a still further alternate embodiment, the top layer 5 has a flap in a fan fold configuration with multiple sheets between the flap and the top layer. In a still further alternate embodiment, the top layer has a flap in an accordion fold configuration with multiple sheets hingedly connected on alternating longitudinal edges. In this alternate embodiment, the flap expands outwards from the top layer and displays multiple surfaces of the sheets for printing of marketing messages.

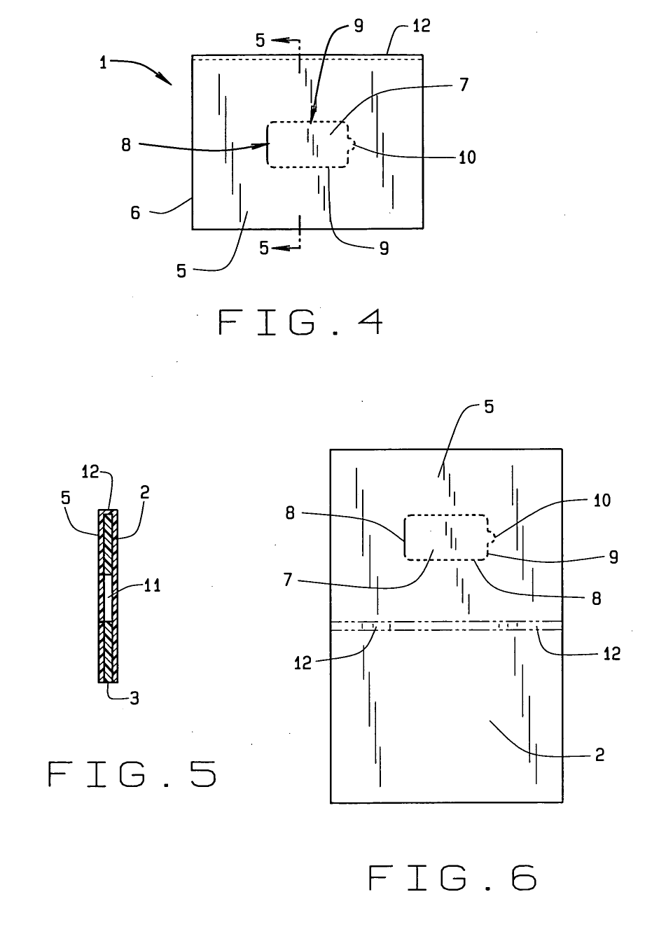

FIG. 4 though shows an alternate embodiment of the mailer that has a spine 12 upon a longitudinal edge. The alternate embodiment has a top layer 5 generally rectangular in shape and a tab 7 generally centered in the top layer as previously described. The top layer 5 joins contiguously to the bottom layer along a spine 12, here shown as the top longitudinal edge. The top layer has a rectangular tab that forms upon a fold line 8 upon one lateral edge and then intermittent linear scoring 9 upon the longitudinal edges and the remaining lateral edge. The remaining lateral edge has a partial knob 10 that extends into the top layer. The tab is generally much smaller in dimensions than the mailer. The recipient of the mailer works the knob free from the mailer then pulls the knob to open the pocket 11 revealing the sample contained inside. Behind the tab 7, the recipient removes the sample contained within the pocket.

The pocket 11 appears in FIG. 5 as a portion of the middle layer 3, one of three layers in the preferred embodiment. The middle layer has a generally rectangular shape to match the top layer. The middle layer has a thickness suitable to the sample placed within the mailer. The pocket 11 is formed by removing a rectangular shaped central portion of the middle layer. Opposite the top layer, the alternate embodiment has the bottom layer 2. The bottom layer has a rectangular shape also to match the top layer. The bottom layer is contiguous with the top layer through the spine located across the top longitudinal edge of the middle layer. The bottom layer is continuous and has no scoring or openings there through. The bottom layer serves as the backing to the pocket and assists in retaining a sample in the pocket along with the top layer.

With the middle layer removed, the alternate embodiment has the contiguous top layer 5 and bottom layer 2 shown in FIG. 6. The top layer is shown towards the left having a generally rectangular shape with the knob of the flap upwards. Upon a longitudinal edge of the top layer, the spine 12 joins to the top layer generally centered between the top layer and the bottom layer. The spine has a width approximately that of the thickness of the middle layer. The spine is flanked by a pair of fold lines to which the top layer and bottom layer fold respectively. Upon an edge of the spine, a longitudinal edge of the bottom layer joins the spine opposite the top layer.

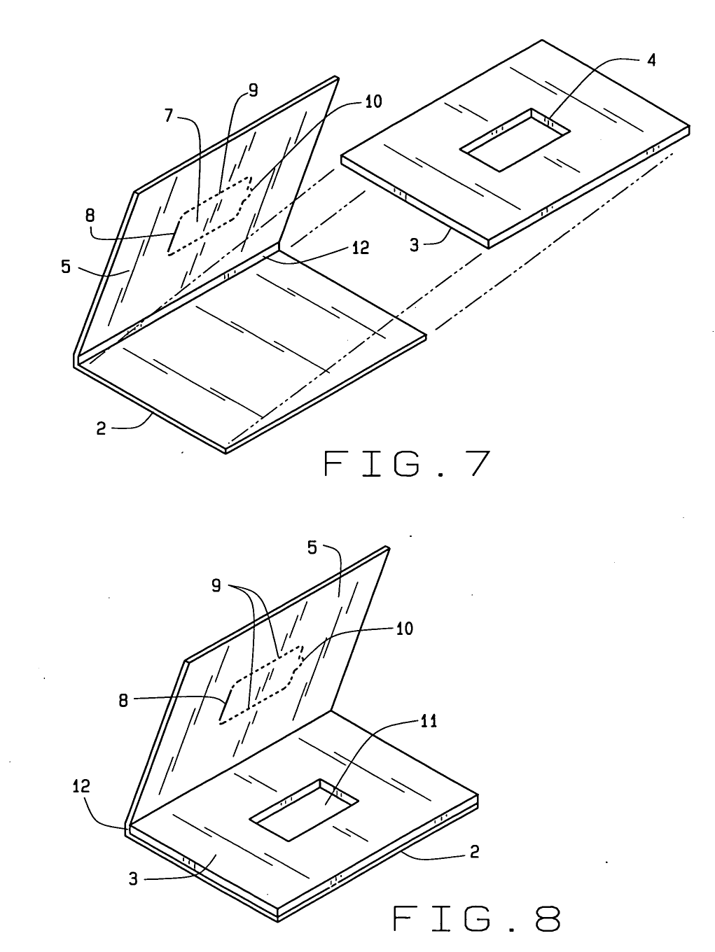

The layers of the preferred embodiment are assembled as shown in FIGS. 7 and 8. The bottom layer 2 is placed down first with the spine 12 located towards the top of the invention and the top layer 5 opening upwards. Then an adhesive is applied to the bottom layer and the spine. The middle layer 3 is oriented to fit upon the bottom layer and against the spine. Then the middle layer is applied to the adhesive surface of the bottom layer and abuts the spine 12 as shown in FIG. 8. Then further adhesive is applied to the middle layer opposite the bottom layer. A sample is then placed within the opening 4 of the middle layer. The sample is slightly less in thickness than the middle layer 3 and fits within the dimensions of the opening 4. Next, the top layer is folded along the spine and applied to the middle layer upon the adhesive. The top layer is oriented to also match the shape of the bottom layer and the middle layer. The top layer is also positioned so the tab 7 is centered upon the opening 4 in the middle layer and above the sample. The three layers are then pressed together to firmly bond them and the sample within a pocket formed in the three layers.

From the aforementioned description, a three dimensional mailer has been described. The three dimensional mailer and its various components may be manufactured from many materials, including but not limited to singly or in combination, paper, cardstock, cardboard, open cell foam, closed cell foam, polymers, polyester, polyethylene, polypropylene, polyvinyl chloride, nylon, ferrous and non-ferrous metal foils and their alloys, and composites.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mailer, for containing a thick sample later opened by a recipient, comprising:
a bottom layer, generally thin and planar;
a middle layer, generally thick and planar, having an opening therethrough adapted to receive said sample and joining to said bottom layer;
a top layer, generally thin and planar, having at least one lateral edge, a releasable tab, said top layer positioned upon said middle layer, and said tab providing access to said opening; and,
adhesive applied between said layers thus assembling said mailer.

2. The mailer of claim 1 further comprising:
said tab having a fold line located towards said lateral edge of said top layer, and a scoring line defining the remaining perimeter of said tab.

3. The mailer of claim 2 wherein said scoring line forms said tab into a generally rectangular shape and said mailer is generally rectangular in shape.

4. The mailer of claim 2 further comprising:
said tab having a knob extending outward and opposite said fold line and into said top layer for a recipient of said mailer to grasp and thus to open said mailer.

5. The mailer of claim 3 further comprising:
a pocket, forming in said opening and enclosed by said tab and said bottom layer, into which said sample is deposited.

6. The mailer of claim 5 wherein said pocket is rectangular.

7. The mailer of claim 1 further comprising:
said top layer having a longitudinal edge perpendicular to said lateral edge and a flap contiguous with said longitudinal edge forming a fold line, said flap folding over said top layer.

8. The mailer of claim 7 wherein said flap has the dimensions of said top layer.

9. A mailer, for containing a thick sample later opened by a recipient upon delivery, comprising:
a bottom layer, generally thin and planar having a longitudinal edge, contiguous with a spine upon said longitudinal edge and a top layer generally thin and planar having a longitudinal edge contiguous with said spine and opposite said bottom layer, said spine including two parallel fold lines contiguous with said bottom layer and said top layer respectively;
a middle layer, generally thick and planar, having an opening therethrough adapted to receive said sample and inserting between said top layer and said bottom layer abutting said spine and joining to said bottom layer;
said top layer having at least one lateral edge, a releasable tab, said top layer closing upon said middle layer and said tab providing access to said opening; and,
adhesive applied between said layers thus assembling said mailer.

10. The mailer of claim 9 further comprising:
said tab having a fold line located towards a lateral edge of said top layer and perpendicular to said spine, and a scoring line defining the remaining perimeter of said tab.

11. The mailer of claim 10 wherein said scoring line forms said tab into a generally rectangular shape and said mailer is generally rectangular in shape.

12. The mailer of claim 10 further comprising:
said tab having a knob extending outward and opposite said fold line and into said top layer for a recipient of said mailer to grasp and thus to open said mailer.

13. The mailer of claim 11 further comprising:
a pocket, forming in said opening and enclosed by said tab and said bottom layer, and into which said sample is deposited.

14. The mailer of claim 13 wherein said pocket is rectangular.

15. A mailer, for containing a thick sample later opened by a recipient, comprising:
at least two layers, generally thin and planar;
a middle layer, generally thick and planar, having an opening therethrough adapted to receive said sample and joining to said layers;
the topmost of said layers, having at least one lateral edge, a releasable rectangular tab, and said tab providing access to said opening and having a fold line located towards a lateral edge of said mailer, and a scoring line defining the remaining perimeter of said tab as generally rectangular;
adhesive applied between said layers thus assembling said mailer; and,
said tab having a knob extending outward and opposite said fold line and into said top layer for a recipient of said mailer to grasp and thus to open said mailer.

16. The mailer of claim 15 further comprising:
the topmost of said layers having a longitudinal edge perpendicular to said lateral edge and a flap contiguous with said longitudinal edge forming a fold line, said flap folding over said top layer.
